(19) United States
(12) Patent Application Publication
(10) Pub. No.: US 2012/0128937 A1
(43) Pub. Date: May 24, 2012

(54) GLASS OPTICAL ELEMENT, METHOD OF PRODUCING THEREOF AND MOLD

(76) Inventors: Ryosuke Imajima, Osaka (JP); Toshiya Tomisaka, Osaka (JP)

(21) Appl. No.: 13/292,282

(22) Filed: Nov. 9, 2011

(30) Foreign Application Priority Data
Nov. 24, 2010 (JP) 2010-261225

(51) Int. Cl. C03B 11/06; B32B 3/30

(52) U.S. Cl. 428/156; 65/305; 65/66

(57) ABSTRACT

A mold for use in production of a glass optical element includes an upper mold and a lower mold on which a molten glass is dropped, the lower mold being provided with a molding surface for press molding the molten glass with the upper mold. A recess for forming a positioning protrusion on the glass optical element is provided at an outer side of the molding surface. An inclined section is provided at an inner circumferential surface of the recess closer to the molding surface. The inclined section is inclined such that, when the molten glass dropped on the molding surface spreads toward the outer side, the molten glass enters the recess while maintaining contact with the inclined section.

This application is based on Japanese Patent Application No. 2010-261225 filed with the Japan Patent Office on Nov. 24, 2010, the entire content of which is hereby incorporated by reference.

### BACKGROUND OF THE INVENTION

1. Field of the Invention

The present invention relates to a glass optical element, a method of producing thereof and a mold, and more particularly to a glass optical element with a positioning protrusion formed thereon, a method of producing the glass optical element, and a mold for use in production of the glass optical element.

2. Description of the Related Art

A glass optical element is produced by press molding a molten glass with a mold (see Japanese Laid-Open Patent Publication No. 2004-256381). Referring to FIGS. 23 to 26, a typical method of producing a glass optical element will be described. The production method includes steps ST101 to ST103 (first to third steps) as a production process.

Referring to FIG. 23, in step ST101, an upper mold 110 and a lower mold 120 as a mold, a nozzle 130, and a molten glass 140 are prepared. Nozzle 130 is heated by a heating device (not shown). By heating nozzle 130, part of molten glass 140 is exposed at the lower end of nozzle 130 as a molten glass 141.

Upper mold 110 has a flat lower end surface 111 and a spherically-shaped molding surface 112 provided concavely. Lower mold 120 has a flat upper end surface 121, a spherically-shaped molding surface 122 provided convexly, and recesses 123 intermittently provided concavely around molding surface 122. Recesses 123 are used to form positioning protrusions on a glass optical element. These protrusions are used when the glass optical element is attached to a substrate or the like.

Referring to FIG. 24, in step ST102, nozzle 130 is further heated. As indicated by an arrow AR8, molten glass 141 separates from nozzle 130. Molten glass 141 is dropped toward lower mold 120. Referring to FIG. 25, in step ST103, molten glass 141 contacts molding surface 122 of lower mold 120. As indicated by an arrow AR9, the contact (hit) between molten glass 141 and molding surface 122 causes molten glass 141 to spread outwardly from the approximate center of molding surface 122.

Referring to FIG. 26, as indicated by an AR10, molten glass 141 further spreads outwardly from the approximate center of molding surface 122. Molten glass 141 covers molding surface 122, and also tends to enter recess 123. After the elapse of a predetermined time since molten glass 141 has contacted molding surface 122 of lower mold 120, lower mold 120 is moved to a position under upper mold 110, and is also moved upwardly (not shown). Molten glass 141 is press molded with upper mold 110 and lower mold 120, so that a glass optical element (not shown) is obtained.

### SUMMARY OF THE INVENTION

FIG. 27 is a sectional view showing enlargedly a region surrounded by the line XXVII in FIG. 26. As described above, upon contacting (hitting) molding surface 122, molten glass 141 spreads outwardly from the approximate center of molding surface 122. Molten glass 141 covers molding surface 122, and also tends to enter recess 123 (see arrow AR10).

However, as shown in FIG. 27, molten glass 141 may not enter recess 123 under the action of surface tension of molten glass 141 generated by the outward spread of molten glass 141 or the like. Even though pressed with upper mold 110 and lower mold 120, molten glass 141 may not enter recess 123. This raises an issue that a positioning protrusion is not formed favorably on a glass optical element.

The present invention has an object to provide a glass optical element with a positioning protrusion formed thereon favorably, a method of producing the glass optical element, and a mold for use in production of the glass optical element.

A mold based on the present invention is a mold for use in production of a glass optical element, including an upper mold provided with a first molding surface, and a lower mold on which a molten glass is dropped, the lower mold being provided with a second molding surface for press molding the molten glass with the first molding surface. A recess for forming a positioning protrusion on the glass optical element is provided at an outer side of one of the first molding surface and the second molding surface. An inclined section is provided at an inner circumferential surface of the recess closer to the one of the first molding surface and the second molding surface. The inclined section is inclined or curved such that, when the molten glass dropped on the second molding surface spreads toward the outer side, the molten glass enters the recess while maintaining contact with the inclined section.

Preferably, the inclined section is formed flat, and an angle formed by the inclined section and a pressing direction in which the upper mold and the lower mold press the molten glass is more than or equal to 45° and less than or equal to 70°.

Preferably, a plurality of the recesses are provided at the outer side of the one of the first molding surface and the second molding surface. Preferably, the recess is provided at the outer side of the second molding surface.

A method of producing a glass optical element based on the present invention press molds the molten glass using the mold based on the present invention, thereby producing the glass optical element.

A glass optical element based on the present invention is produced by press molding the molten glass using the mold based on the present invention.

According to the present invention, a glass optical element with a positioning protrusion formed thereon favorably, a method of producing the glass optical element, and a mold for use in production of the glass optical element can be obtained.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a sectional view showing a mold according to a first embodiment.

FIG. 2 is a sectional view showing enlargedly a region surrounded by the line II in FIG. 1.

FIG. 3 is a sectional view showing a first step of a method of producing a glass optical element according to the first embodiment.

FIG. 4 is a sectional view showing a second step of the method of producing a glass optical element according to the first embodiment.

FIG. 5 is a sectional view showing a third step of the method of producing a glass optical element according to the first embodiment.

FIG. 6 is a sectional view showing a fourth step of the method of producing a glass optical element according to the first embodiment.

FIG. 7 is a sectional view showing a fifth step of the method of producing a glass optical element according to the first embodiment.

FIG. 8 is a sectional view showing the state before mounting the glass optical element according to the first embodiment on a substrate.

FIG. 9 is a sectional view showing the state after mounting the glass optical element according to the first embodiment on the substrate.

FIG. 10 is a sectional view showing enlargedly part of a mold according to a second embodiment.

FIG. 11 is a sectional view showing the state before mounting a glass optical element according to the second embodiment on a substrate.

FIG. 12 is a sectional view showing a mold according to a third embodiment.

FIG. 13 is a sectional view showing enlargedly a region surrounded by the line XIII in FIG. 12.

FIG. 14 is a sectional view showing the manner in which a molten glass is press molded using the mold according to the third embodiment.

FIG. 15 is a plan view showing part of a mold (lower mold) in Experiment 1.

FIG. 16 is a sectional view taken along the arrow line XVI-XVI in FIG. 15.

FIG. 17 is a sectional view taken along the arrow line XVII-XVII in FIG. 15.

FIG. 18 shows the results of Experiment 1.

FIG. 19 is a plan view showing part of a mold (lower mold) in Experiment 2.

FIG. 20 is a sectional view taken along the arrow line XX-XX in FIG. 19.

FIG. 21 is a sectional view taken along the arrow line XXI-XXI in FIG. 19.

FIG. 22 shows the results of Experiment 2.

FIG. 23 is a sectional view showing a first step of a typical method of producing a glass optical element.

FIG. 24 is a sectional view showing a second step of the typical method of producing a glass optical element.

FIG. 25 is a (first) sectional view showing a third step of the typical method of producing a glass optical element.

FIG. 26 is a (second) sectional view showing the third step of the typical method of producing a glass optical element.

FIG. 27 is a sectional view showing enlargedly a region surrounded by the line XXVII in FIG. 26.

### DESCRIPTION OF THE PREFERRED EMBODIMENTS

Each embodiment and each example based on the present invention will be described below with reference to the drawings. It is noted that, when the number, amount and the like are mentioned in the description of each embodiment and each example, the scope of the present invention is not necessarily limited to that number, amount and the like unless otherwise specified. In the description of each embodiment and each example, identical and corresponding parts are denoted by an identical reference character, and repeated description thereof may not be provided. The features of the respective embodiments and examples have been initially intended to be used in combination as appropriate.

### First Embodiment

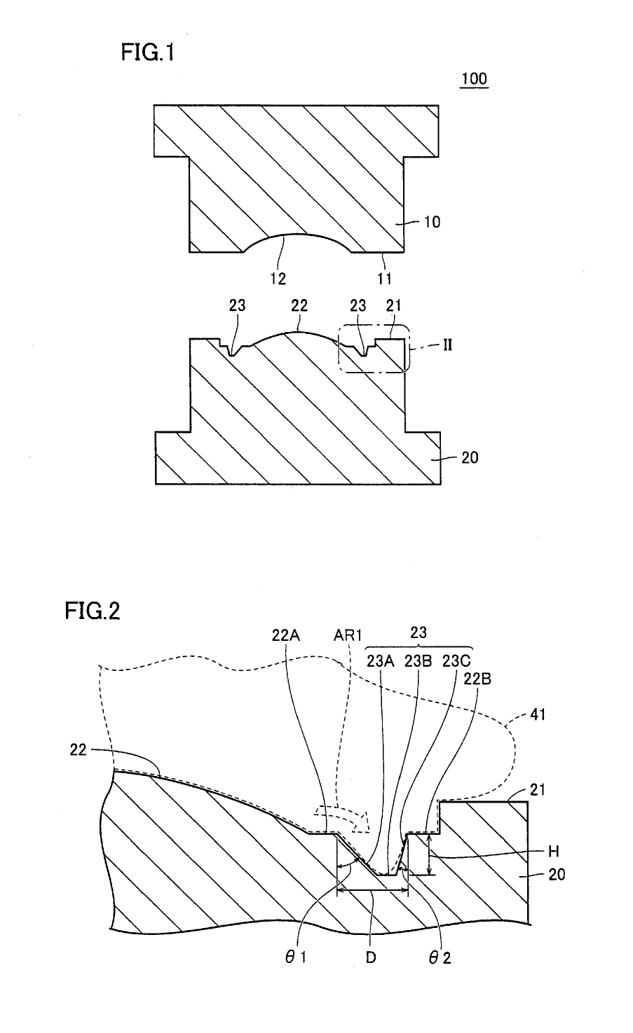

Referring to FIGS. 1 and 2, a mold 100 according to the present embodiment will be described. FIG. 1 is a sectional view showing mold 100. FIG. 2 is a sectional view showing enlargedly a region surrounded by the line II in FIG. 1.

(Mold 100)

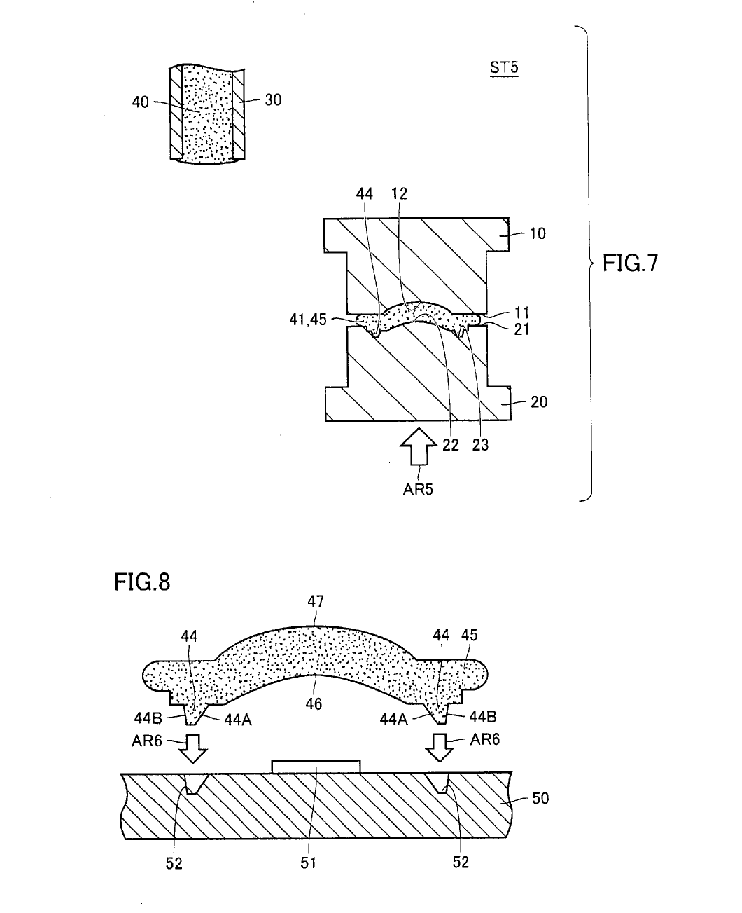

Referring to FIG. 1, mold 100 includes an upper mold 10 and a lower mold 20. Upper mold 10 and lower mold 20 are used to produce a glass optical element 45 (see FIGS. 7 and 8). Upper mold 10 has a flat lower end surface 11 and a spherically-shaped molding surface 12 (a first molding surface) provided concavely.

A protective film (not shown) against a molten glass 41 (see FIGS. 4 and 5) may be formed previously on each surface of lower end surface 11 and molding surface 12. This protective film is made of a chromium (Cr) metal or chromium nitride, for example. To form this protective film, PVD (Physical Vapor Deposition), such as vapor deposition or sputtering, CVD (Chemical Vapor Deposition), ion implantation, or the like is used.

Lower mold 20 has a flat upper end surface 21, a spherically-shaped molding surface 22 (a second molding surface) provided convexly, and at least one recess 23 provided concavely around molding surface 22. Four recesses 23 can be provided at intervals of 90°, for example, in a circumferential direction about molding surface 22. Recess 23 is fondled into a cone, a polygonal pyramid or a frustum, for example. As used herein, frustum means a configuration obtained by cutting away the top portion of a polygonal pyramid, such as a pyramid, or a cone, for example, along a plane of a smaller area than the bottom.

A protective film (not shown) against molten glass 41 (see FIGS. 4 and 5) may also be formed previously on each surface of upper end surface 21, molding surface 22, and recesses 23. To form this protective film, a technique similar to that adopted for forming the protective film on lower end surface 11 and molding surface 12 of upper mold 10 may be used.

Referring to FIG. 2, molten glass 41 is dropped on molding surface 22 of lower mold 20 (which will be described later in detail). Molding surface 22 press molds molten glass 41 dropped on molding surface 22 in cooperation with molding surface 12 of upper mold 10 (see FIG. 1).

A flat surface 22A extending horizontally away from molding surface 22 is provided at the outer side of molding surface 22. Recess 23 includes an inclined section 23A, a bottom section 23B, and a rear section 23C, as inner circumferential surfaces. Recess 23 in the present embodiment has a depth H of 0.4 mm.

Inclined section 23A is located closer to molding surface 22, and continues to flat surface 22A. Inclined section 23A is inclined such that, when molten glass 41 dropped toward molding surface 22 contacts (hits) molding surface 22 and thereby spreads outwardly, molten glass 41 enters recess 23 (see arrow AR1) while maintaining contact with inclined section 23A.

In the present embodiment, inclined section 23A is inclined at an angle θ1 in the pressing direction in which upper mold 10 (see FIG. 1) and lower mold 20 press molten glass 41 (in the present embodiment, in the vertical direction of the drawing sheet of FIG. 2). Angle θ1 in the present embodiment is 50°.

Angle θ1 is set such that molten glass 41 enters recess 23 (see arrow AR1) while maintaining contact with inclined section 23A, in accordance with the viscosity of molten glass 41, the temperature of molten glass 41, the drop height of molten glass 41 relative to lower mold 20, and the like.

For example, the higher the viscosity of molten glass 41, the higher the surface tension of molten glass 41 spreading from molding surface 22 toward flat surface 22A. Under the action of the surface tension of molten glass 41, molten glass 41 is less likely to enter recess 23. In this case, angle θ1 may be increased such that molten glass 41 can enter recess 23 while maintaining contact with inclined section 23A. Angle θ1 may be increased within such a range that a positioning protrusion 44 (see FIG. 7 or 8) that will be formed on glass optical element 45 (see FIG. 7 or 8) by means of recess 23 can exert its positioning function.

The lower the viscosity of molten glass 41, the lower the surface tension of molten glass 41 spreading from molding surface 22 toward flat surface 22A. Molten glass 41 is more likely to enter recess 23. In this case, angle θ1 can be decreased within such a range that molten glass 41 can enter recess 23 while maintaining contact with inclined section 23A. As angle θ1 decreases, positioning protrusion 44 (see FIG. 7 or 8) that will be formed on glass optical element 45 (see FIG. 7 or 8) by means of recess 23 can exert a higher positioning function.

The higher the temperature of molten glass 41, the lower the viscosity of molten glass 41. The surface tension of molten glass 41 spreading from molding surface 22 toward flat surface 22A decreases. Molten glass 41 is more likely to enter recess 23. In this case, angle θ1 can be decreased within such a range that molten glass 41 can enter recess 23 while maintaining contact with inclined section 23A. As angle θ1 decreases, positioning protrusion 44 (see FIG. 7 or 8) that will be formed on glass optical element 45 (see FIG. 7 or 8) by means of recess 23 can exert a higher positioning function.

The lower the temperature of molten glass 41, the higher the viscosity of molten glass 41. The surface tension of molten glass 41 spreading from molding surface 22 toward flat surface 22A increases. Under the action of the surface tension of molten glass 41, molten glass 41 is less likely to enter recess 23. In this case, angle θ1 may be increased such that molten glass 41 can enter recess 23 while maintaining contact with inclined section 23A. Angle θ1 may be increased within such a range that positioning protrusion 44 (see FIG. 7 or 8) that will be formed on glass optical element 45 (see FIG. 7 or 8) by means of recess 23 can exert its positioning function.

The greater the drop height of molten glass 41 relative to lower mold 20, the greater the shock when molten glass 41 contacts (hits) molding surface 22, and the higher the kinetic energy with which molten glass 41 tends to spread from molding surface 22 toward flat surface 22A. Molten glass 41 is less likely to enter recess 23. In this case, angle θ1 may be increased such that molten glass 41 can enter recess 23 while maintaining contact with inclined section 23A. Angle θ1 may be increased within such a range that positioning protrusion 44 (see FIG. 7 or 8) that will be formed on glass optical element 45 (see FIG. 7 or 8) by means of recess 23 can exert its positioning function.

The smaller the drop height of molten glass 41 relative to lower mold 20, the smaller the shock when molten glass 41 contacts (hits) molding surface 22, and the lower the kinetic energy with which molten glass 41 tends to spread from molding surface 22 toward flat surface 22A. Molten glass 41 is more likely to enter recess 23. In this case, angle θ1 can be decreased within such a range that molten glass 41 can enter recess 23 while maintaining contact with inclined section 23A. As angle θ1 decreases, positioning protrusion 44 (see FIG. 7 or 8) that will be formed on glass optical element 45 (see FIG. 7 or 8) by means of recess 23 can exert a higher positioning function.

Angle θ1 may be optimized in accordance with the viscosity of molten glass 41, the temperature of molten glass 41, the drop height of molten glass 41 relative to lower mold 20, and the like such that molten glass 41 can enter recess 23 while maintaining contact with inclined section 23A and such that a positioning protrusion that will be formed on glass optical element 45 by means of recess 23 can exert a high positioning function.

Bottom section 23B continues to the lower end of inclined section 23A. Bottom section 23B extends horizontally away from inclined section 23A. Rear section 23C continues to the leading end of bottom section 23B in the extending direction. Rear section 23C continues to a flat surface 22B provided horizontally at the inner side below upper end surface 21.

Rear section 23C is inclined at an angle θ2 in the pressing direction in which upper mold 10 (see FIG. 1) and lower mold 20 press molten glass 41 (in the present embodiment, in the vertical direction of the drawing sheet of FIG. 2). In the present embodiment, angle θ2 is 10°. Angle θ2 may be set at more than or equal to 10° and less than or equal to 20° such that positioning protrusion 44 (see FIG. 7 or 8) that will be formed on glass optical element 45 (see FIG. 7 or 8) by means of recess 23 can exert a high positioning function.

A distance D between the upper end of inclined section 23A and the upper end of rear section 23C is 4 mm. Upper mold 10 and lower mold 20 as mold 100 are configured as described above.

(Method of Producing Glass Optical Element)

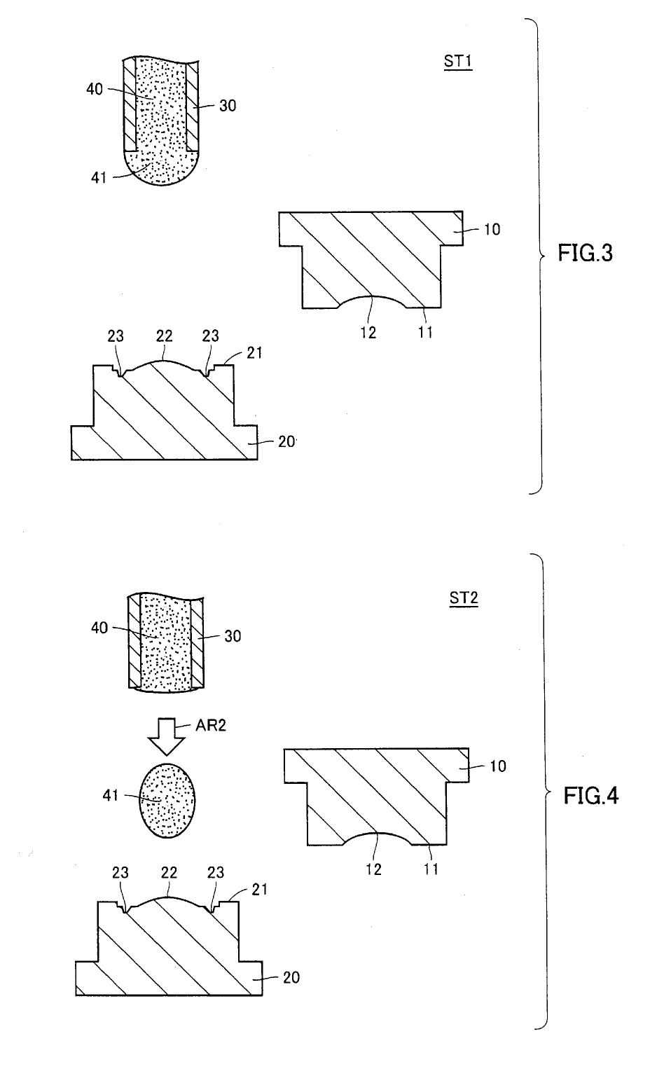

Referring to FIGS. 3 to 7, a method of producing a glass optical element in the present embodiment using mold 100 (upper mold 10 and lower mold 20) will now be described. The production method includes steps ST1 to ST5 (first to fifth steps). FIGS. 3 to 7 are sectional views showing steps ST1 to ST5, respectively.

(Step ST1)

Referring to FIG. 3, in step ST1, upper mold 10 and lower mold 20 as mold 100 described above (see FIG. 1), a nozzle 30, and a molten glass 40 are prepared. A melting furnace (not shown) retaining molten glass 40 is provided above nozzle 30. Nozzle 30 is heated by a heating device (not shown).

Part of molten glass 40 in the melting furnace is conveyed through nozzle 30 to the lower end of nozzle 30 to be exposed as molten glass 41 at the lower end of nozzle 30. Molten glass 41 is accumulated at the lower end of nozzle 30 by surface tension. The viscosity of molten glass 41 is, for example, 101 to 1010 Poise, and preferably 103 to 107 Poise.

(Step ST2)

Referring to FIG. 4, in step ST2, nozzle 30 is further heated. As indicated by an arrow AR2, molten glass 41 separates from nozzle 30. Molten glass 41 is dropped toward molding surface 22 of lower mold 20.

(Step ST3)

Referring to FIG. 5, in step ST3, molten glass 41 contacts molding surface 22 of lower mold 20. As indicated by an arrow AR3, by the contact (hit) between molten glass 41 and molding surface 22, molten glass 41 spreads outwardly from the approximate center of molding surface 22. Molten glass 41 covers molding surface 22, and also enters recess 23.

In the present embodiment, inclined section 23A of recess 23 (see FIG. 2) is inclined such that, when molten glass 41 dropped toward molding surface 22 contacts (hits) molding surface 22 and thereby spreads outwardly, molten glass 41 enters recess 23 while maintaining contact with inclined section 23A. With inclined section 23A being inclined as described above, molten glass 41 can satisfactorily enter (spread inside) recess 23 by the contact with inclined section 23A even under the action of the surface tension of molten glass 41 generated when molten glass 41 spreads outwardly and the like.

(Step ST4)

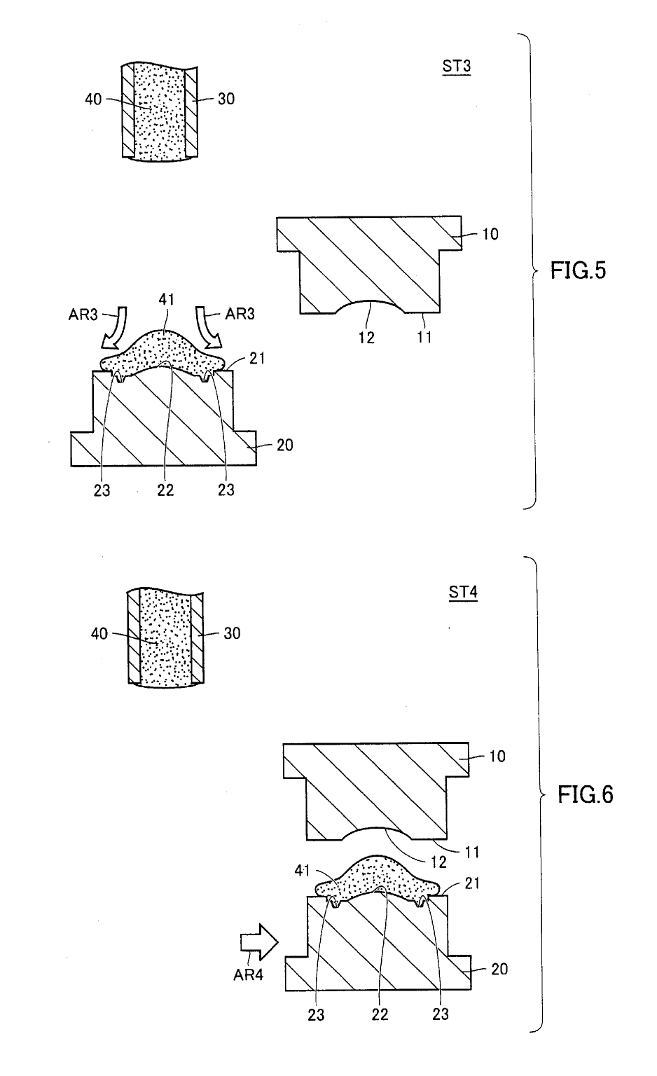

Referring to FIG. 6, in step ST4, lower mold 20 with molten glass 41 supplied thereon is moved to a position under upper mold 10, as indicated by an arrow AR4. Upper mold 10 may be moved to a position above lower mold 20.

(Step ST5)

Referring to FIG. 7, in step ST5, lower mold 20 is moved upwardly after the elapse of a predetermined time since molten glass 41 has contacted molding surface 22 of lower mold 20, as indicated by an arrow AR5. Upper mold 10 may be moved downwardly. The surface of molten glass 41 contacts molding surface 12 of upper mold 10.

Molten glass 41 is pressed with molding surface 12 of upper mold 10 and molding surface 22 of lower mold 20 in a high-temperature atmosphere. Means for moving lower mold 20 (or upper mold 10) so as to press molten glass 41 may be implemented by an air cylinder, an oil hydraulic cylinder, a motor cylinder through use of a servomotor, or the like.

Molten glass 41 spreads between molding surfaces 12 and 22, and also enters recess 23 to spread inside recess 23. Molten glass 41 is heat radiated (dissipated) by means of upper mold 10 and lower mold 20. By solidification of molten glass 41, glass optical element 45 with positioning protrusion 44 formed thereon is obtained.

Referring to FIG. 8, glass optical element 45 can be attached to a substrate 50, for example. Positioning recesses 52 are provided in substrate 50. The number, position and shape of recesses 52 correspond to the number, position and shape of protrusions 44 provided on glass optical element 45, respectively. A light emitting device 51 such as LED (Light Emitting Diode) is mounted on substrate 50.

As indicated by an arrow AR6, protrusions 44 are fitted into recesses 52. Protrusion 44 is fitted with the inner circumferential surface of recess 52 by means of an outer side surface 44B and an inner side surface 44A of protrusion 44. By this fitting, glass optical element 45 is positioned relative to substrate 50. Glass optical element 45 is fixed to substrate 50 with an adhesive (not shown) or the like while being positioned. With glass optical element 45 having protrusions 44, glass optical element 45 can easily be attached to substrate 50.

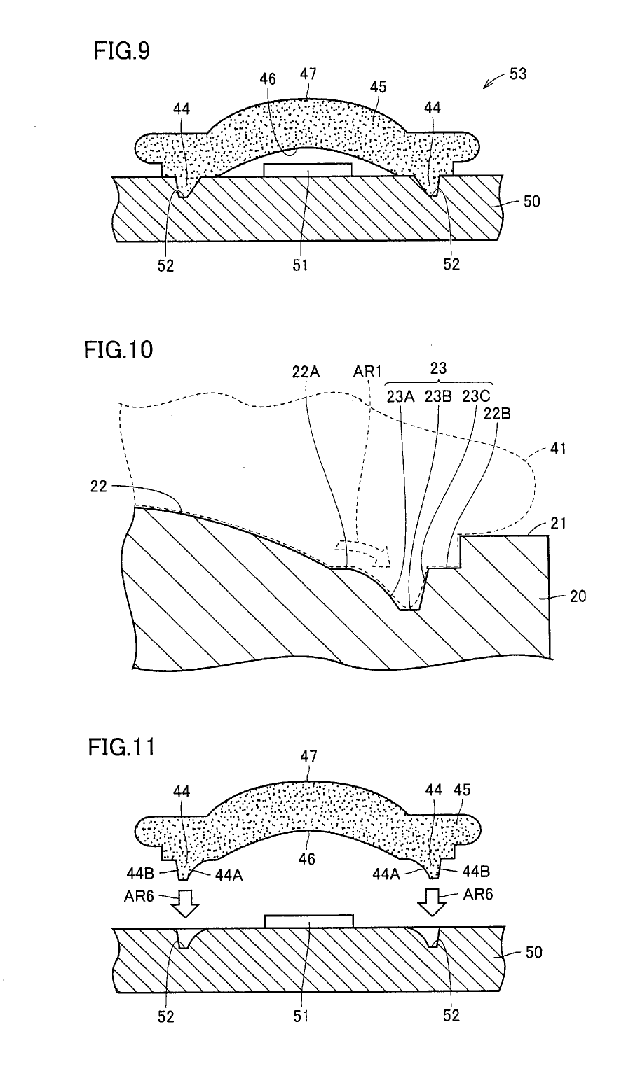

Referring to FIG. 9, a light emitting device 53 is obtained by fixing glass optical element 45 to substrate 50. Light emitted from the light emitting device 51 passes through glass optical element 45 from an optical surface 46 to an optical surface 47. In this case, glass optical element 45 can serve as a diverging lens or a condenser lens.

(Function and Effect)

Referring again to FIG. 2, inclined section 23A of recess 23 (see FIG. 2) is inclined such that, when molten glass 41 dropped toward molding surface 22 contacts (hits) molding surface 22 and thereby spreads outwardly, molten glass 41 enters recess 23 while maintaining contact with inclined section 23A. By the contact with inclined section 23A, molten glass 41 can enter recess 23 and spread inside recess 23.

By solidification of molten glass 41 spread inside recess 23, positioning protrusion 44 can be formed favorably on glass optical element 45 (see FIG. 8). Glass optical element 45 can easily be attached to substrate 50 of light emitting device 53 (see FIG. 9) or the like by means of protrusions 44. Glass optical element 45 obtained can easily be attached not only to light emitting device 53 but also to various equipment as various lenses such as, for example, a lens for digital camera, an optical pickup lens for DVD or the like, a camera lens for cellular phone, or a coupling lens for optical communications, or various mirrors.

(Variation of First Embodiment)

Referring again to FIG. 2, inclined section 23A in the above-described first embodiment is inclined such that, when molten glass 41 dropped toward molding surface 22 contacts (hits) molding surface 22 and thereby spreads outwardly, molten glass 41 enters recess 23 (see arrow AR1) while maintaining contact with inclined section 23A.

Inclined section 23A may be inclined such that, when molten glass 41 is pressed with upper mold 10 and lower mold 20 to spread outwardly (see step ST5 in the above-described first embodiment), molten glass 41 enters recess 23 while maintaining contact with inclined section 23A. In this case, angle θ1 of inclined section 23A is set such that molten glass 41 enters recess 23 while maintaining contact with inclined section 23A, in accordance with the viscosity of molten glass 41, the temperature of molten glass 41, the degree that molten glass 41 is pressed with upper mold 10 and lower mold 20, and the like.

For example, the greater the degree that molten glass 41 is pressed with upper mold 10 and lower mold 20, the greater the force with which molten glass 41 is pushed into recess 23. Molten glass 41 is more likely to enter recess 23. In this case, angle θ1 can be decreased within such a range that molten glass 41 can enter recess 23 while maintaining contact with inclined section 23A. As angle θ1 decreases, positioning protrusion 44 (see FIG. 7 or 8) that will be foamed on glass optical element 45 (see FIG. 7 or 8) by means of recess 23 can exert a higher positioning function.

The smaller the degree that molten glass 41 is pressed with upper mold 10 and lower mold 20, the smaller the force with which molten glass 41 is pushed into recess 23. Molten glass 41 is less likely to enter recess 23. In this case, angle θ1 may be increased such that molten glass 41 can enter recess 23 while maintaining contact with inclined section 23A. Angle θ1 may be increased within such a range that positioning protrusion 44 (see FIG. 7 or 8) that will be formed on glass optical element 45 (see FIG. 7 or 8) by means of recess 23 can exert its positioning function.

### Second Embodiment

Referring to FIG. 10, a mold according to the present embodiment will be described. Here, a difference from mold 100 (see FIGS. 1 and 2) in the above-described first embodiment will be described. FIG. 10 is a sectional view showing enlargedly part of a mold (lower mold 20) according to the present embodiment. FIG. 10 corresponds to FIG. 2 in the above-described first embodiment.

In the mold according to the present embodiment, inclined section 23A of recess 23 in lower mold 20 is curved. Inclined section 23A continues to flat surface 22A, and is curved such that, when molten glass 41 dropped toward molding surface 22 contacts (hits) molding surface 22 and thereby spreads outwardly, molten glass 41 enters recess 23 (see arrow AR1) while maintaining contact with inclined section 23A.

Inclined section 23A may be curved and inclined such that, when molten glass 41 is pressed with upper mold 10 and lower mold 20 to spread outwardly (see step ST5 in the above-described first embodiment), molten glass 41 enters recess 23 while maintaining contact with inclined section 23A.

Molten glass 41 can enter recess 23 by the contact with inclined section 23A even under the action of the surface tension of molten glass 41 generated when molten glass 41 spreads outwardly and the like. The mold according to the present embodiment can achieve similar function and effect to those of mold 100 according to the above-described first embodiment.

Referring to FIG. 11, glass optical element 45 obtained through use of the mold according to the present embodiment can also be attached to substrate 50. As indicated by arrow AR6, protrusions 44 are fitted into recesses 52. Protrusion 44 is fitted with the inner circumferential surface of recess 52 by means of outer side surface 44B and inner side surface 44A of protrusion 44. By this fitting, glass optical element 45 is positioned relative to substrate 50.

In the present embodiment, inner side surface 44A is curved unlike the above-described first embodiment. When glass optical element 45 is positioned on substrate 50, the contact between outer side surface 44B and the inner circumferential surface of recess 52 mainly causes positioning protrusion 44 to exert its function.

### Third Embodiment

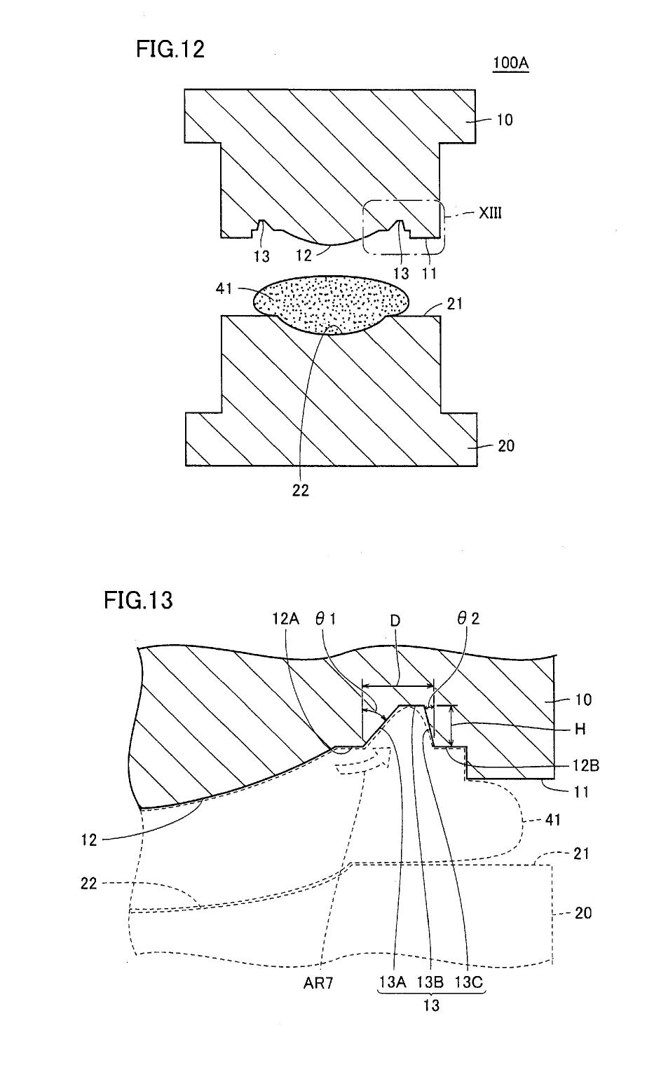

Referring to FIGS. 12 and 13, a mold 100A according to the present embodiment will be described. Here, a difference from mold 100 (see FIGS. 1 and 2) in the above-described first embodiment will be described. FIG. 12 is a sectional view showing mold 100A. FIG. 12 shows the state where molten glass 41 has been supplied on lower mold 20 of mold 100A. FIG. 13 is a sectional view showing enlargedly a region surrounded by the line XIII in FIG. 12.

Referring to FIG. 12, mold 100A includes upper mold 10 and lower mold 20. Upper mold 10 has flat lower end surface 11 and spherically-shaped molding surface 12 (a first molding surface) provided concavely, and at least one recess 13 provided concavely around molding surface 12. Four recesses 13 can be provided at intervals of 90°, for example, in a circumferential direction about molding surface 22. Recess 13 is formed into a cone, a polygonal pyramid or a frustum, for example. A protective film (not shown) against molten glass 41 may be formed previously on each surface of lower end surface 11, molding surface 12, and recess 13.

Lower mold 20 has flat upper end surface 21 and spherically-shaped molding surface 22 (a second molding surface) provided convexly. A protective film (not shown) against molten glass 41 may also be formed previously on each surface of upper end surface 21 and molding surface 22.

Referring to FIG. 13, upper mold 10 will be described in detail. As shown in FIG. 13, molten glass 41 (indicated by dotted lines) is supplied on molding surface 22 of lower mold 20 (indicated by dotted lines). FIG. 13 shows the state where, upon supply of molten glass 41 on molding surface 22, molten glass 41 is pressed with upper mold 10 and lower mold 20 to spread outwardly from the approximate center of molding surface 22.

A flat surface 12A extending horizontally away from molding surface 12 is provided at the outer side of molding surface 12 of upper mold 10. Recess 13 includes an inclined section 13A, a bottom section 13B, and a rear section 13C, as inner circumferential surfaces. Recess 13 in the present embodiment has a depth H of 0.4 mm.

Inclined section 13A is located closer to molding surface 12, and continues to flat surface 12A. Inclined section 13A is inclined such that, when molten glass 41 is pressed with upper mold 10 and lower mold 20 to spread outwardly, molten glass 41 enters recess 13 (see an arrow AR7) while maintaining contact with inclined section 13A.

In the present embodiment, inclined section 13A is inclined at angle θ1 in the pressing direction in which upper mold 10 (see FIG. 12) and lower mold 20 press molten glass 41 (in the present embodiment, in the vertical direction of the drawing sheet of FIG. 13). Angle θ1 in the present embodiment is 50°.

Angle θ1 is set such that molten glass 41 enters recess 13 while maintaining contact with inclined section 13A, in accordance with the viscosity of molten glass 41, the temperature of molten glass 41, the degree that molten glass 41 is pressed with upper mold 10 and lower mold 20, and the like.

For example, the higher the viscosity of molten glass 41, the higher the surface tension of molten glass 41 spreading from molding surface 12 toward flat surface 12A. Under the action of the surface tension of molten glass 41, molten glass 41 is less likely to enter recess 13. In this case, angle θ1 may be increased such that molten glass 41 can enter recess 13 while maintaining contact with inclined section 13A. Angle θ1 may be increased within such a range that positioning protrusion 44 (see FIG. 7 or 8) that will be formed on glass optical element 45 (see FIG. 7 or 8) by means of recess 13 can exert its positioning function.

The lower the viscosity of molten glass 41, the lower the surface tension of molten glass 41 spreading from molding surface 12 toward flat surface 12A. Molten glass 41 is more likely to enter recess 13. In this case, angle θ1 can be decreased within such a range that molten glass 41 can enter recess 13 while maintaining contact with inclined section 13A. As angle θ1 decreases, positioning protrusion 44 (see FIG. 7 or 8) that will be formed on glass optical element 45 by means of recess 13 can exert a higher positioning function.

The higher the temperature of molten glass 41, the lower the viscosity of molten glass 41. The surface tension of molten glass 41 spreading from molding surface 12 toward flat surface 12A decreases. Molten glass 41 is more likely to enter recess 13. In this case, angle θ1 can be decreased within such a range that molten glass 41 can enter recess 13 while maintaining contact with inclined section 13A. As angle θ1 decreases, positioning protrusion 44 (see FIG. 7 or 8) that will be formed on glass optical element 45 by means of recess 13 can exert a higher positioning function.

The lower the temperature of molten glass 41, the higher the viscosity of molten glass 41. The surface tension of molten glass 41 spreading from molding surface 12 toward flat surface 12A increases. Under the action of the surface tension of molten glass 41, molten glass 41 is less likely to enter recess 13. In this case, angle θ1 may be increased such that molten glass 41 can enter recess 13 while maintaining contact with inclined section 13A. Angle θ1 may be increased within such a range that positioning protrusion 44 (see FIG. 7 or 8) that will be formed on glass optical element 45 (see FIG. 7 or 8) by means of recess 13 can exert its positioning function.

For example, the greater the degree that molten glass 41 is pressed with upper mold 10 and lower mold 20, the greater the force with which molten glass 41 is pushed into recess 13. Molten glass 41 is more likely to enter recess 13. In this case, angle θ1 can be decreased within such a range that molten glass 41 can enter recess 13 while maintaining contact with inclined section 13A. As angle θ1 decreases, positioning protrusion 44 (see FIG. 7 or 8) that will be formed on glass optical element 45 by means of recess 13 can exert a higher positioning function.

The smaller the degree that molten glass 41 is pressed with upper mold 10 and lower mold 20, the smaller the force with which molten glass 41 is pushed into recess 13. Molten glass 41 is less likely to enter recess 13. In this case, angle θ1 may be increased such that molten glass 41 can enter recess 13 while maintaining contact with inclined section 13A. Angle θ1 may be increased within such a range that a positioning protrusion 44 (see FIG. 7 or 8) that will be formed on glass optical element 45 (see FIG. 7 or 8) by means of recess 13 can exert its positioning function.

Angle θ1 may be optimized in accordance with the viscosity of molten glass 41, the temperature of molten glass 41, the degree that molten glass 41 is pressed with upper mold 10 and lower mold 20, and the like such that molten glass 41 can enter recess 13 while maintaining contact with inclined section 13A and such that a positioning protrusion that will be formed on glass optical element 45 by means of recess 13 can exert a high positioning function.

Bottom section 13B continues to the upper end of inclined section 13A. Bottom section 13B extends horizontally away from inclined section 13A. Rear section 13C continues to the leading end of bottom section 13B in the extending direction. Rear section 13C continues to a flat surface 12B provided horizontally at the inner side above lower end surface 11.

Rear section 13C is inclined at angle θ2 in the pressing direction in which upper mold 10 (see FIG. 12) and lower mold 20 press molten glass 41 (in the present embodiment, in the vertical direction of the drawing sheet of FIG. 13). In the present embodiment, angle θ2 is 10°. Angle θ2 may be set at more than or equal to 10° and less than or equal to 20° such that positioning protrusion 44 (see FIG. 7 or 8) that will be formed on glass optical element 45 (see FIG. 7 or 8) by means of recess 13 can exert a high positioning function.

Distance D between the lower end of inclined section 13A and the lower end of rear section 13C is 4 mm. Upper mold 10 and lower mold 20 as mold 100A are configured as described above.

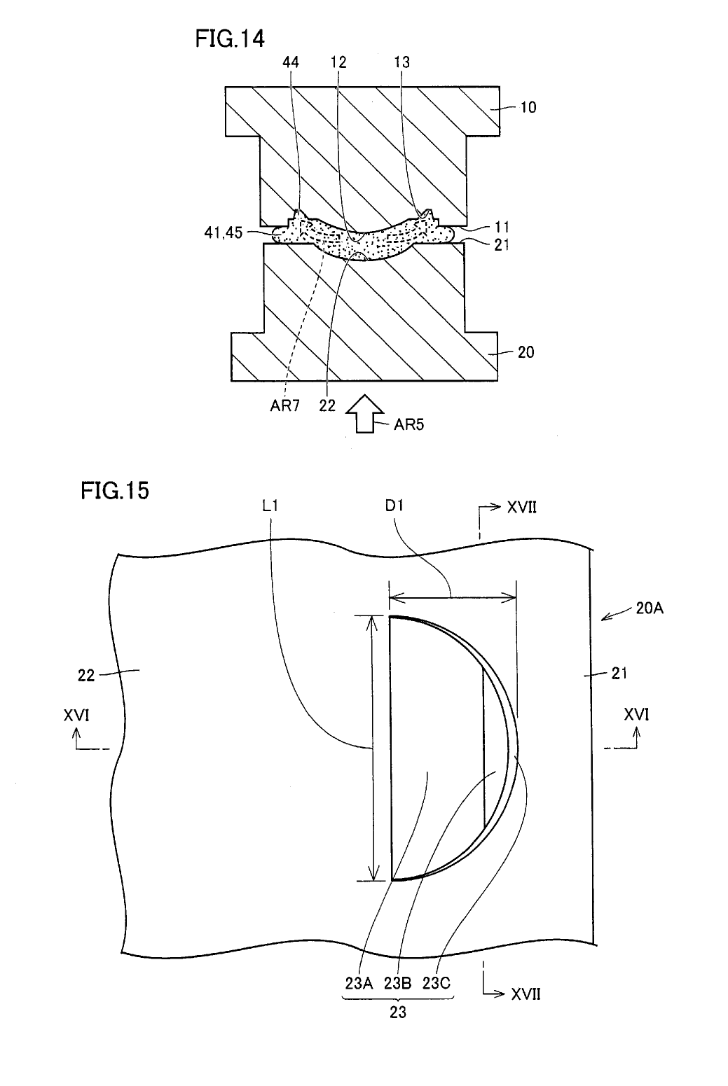

Referring to FIG. 14, when producing a glass optical element using mold 100A (upper mold 10 and lower mold 20), lower mold 20 with molten glass 41 supplied on molding surface 22 is moved upwardly as indicated by arrow AR5. The surface of molten glass 41 contacts molding surface 12 of upper mold 10.

Molten glass 41 is pressed with molding surface 12 of upper mold 10 and molding surface 22 of lower mold 20 in a high-temperature atmosphere. Molten glass 41 spreads between molding surfaces 12 and 22. Molten glass 41 enters recess 13, and spreads inside recess 13 (see arrow AR7). Molten glass 41 is heat radiated (dissipated) by means of upper mold 10 and lower mold 20. By solidification of molten glass 41, glass optical element 45 with positioning protrusion 44 formed thereon is obtained.

(Function and Effect)

Referring again to FIG. 13, inclined section 13A of recess 13 is inclined such that, when molten glass 41 is pressed with upper mold 10 and lower mold 20 to spread outwardly, molten glass 41 enters recess 13 while maintaining contact with inclined section 13A. By the contact with inclined section 13A, molten glass 41 can enter recess 13 and spread inside recess 13.

By solidification of molten glass 41 spread inside recess 13, positioning protrusion 44 can be formed favorably on glass optical element 45 (see FIG. 14). Glass optical element 45 can easily be attached to a substrate of a light emitting device or the like by means of protrusion 44. Glass optical element 45 obtained can easily be attached not only to the light emitting device but also to various equipment as various lenses such as, for example, a lens for digital camera, an optical pickup lens for DVD or the like, a camera lens for cellular phone, or a coupling lens for optical communications, or various mirrors.

### EXAMPLES AND COMPARATIVE EXAMPLES

### Experiment 1

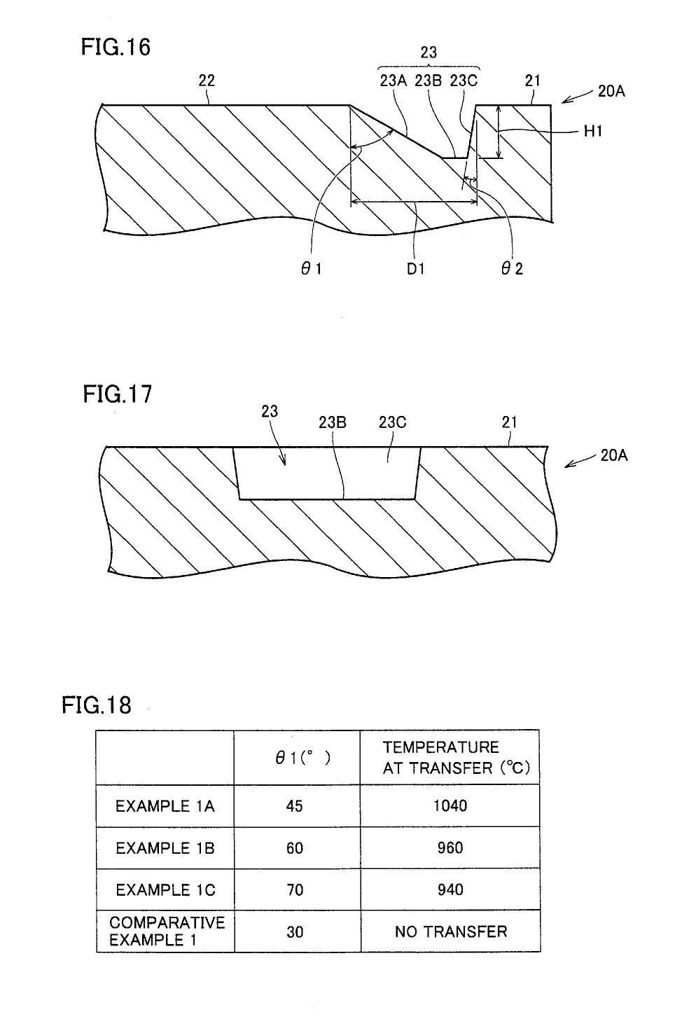

The results of Experiment 1 conducted based on the above-described first embodiment will be described. As will be described later in detail with reference to FIG. 18, Examples 1A, 1B, and 1C, and Comparative Example 1 with angle θ1 (see FIG. 16) varied from one another were conducted as Experiment 1. FIG. 15 is a plan view showing part of a lower mold 20A used in this experiment. FIG. 16 is a sectional view taken along the arrow line XVI-XVI in FIG. 15. FIG. 17 is a sectional view taken along the arrow line XVII-XVII in FIG. 15.

Referring to FIG. 15, lower mold 20A is provided with recess 23 between upper end surface 21 and molding surface 22. Recess 23 is formed into a generally semicircular shape as viewed two-dimensionally. Recess 23 has an arc length L1 of 2.8 mm in the vertical direction of the drawing sheet (perpendicular to the direction in which the molten glass spreads). Recess 23 has a width D1 (here, the maximum width of recess 23) of 1.4 mm.

Referring to FIG. 16, in lower mold 20A, molding surface 22 is formed flat. Recess 23 includes inclined section 23A, bottom section 23B, and rear section 23C, as inner circumferential surfaces. Recess 23 has a depth H1 of 0.6 mm. Inclined section 23A is located closer to molding surface 22, and continues to molding surface 22. The surface of inclined section 23A is formed as a flat plane without being curved. Inclined section 23A is inclined at angle θ1 in the pressing direction in which the upper mold (not shown) and lower mold 20A press the molten glass (in the present embodiment, in the vertical direction of the drawing sheet of FIG. 16).

Bottom section 23B continues to the lower end of inclined section 23A. Bottom section 23B extends horizontally away from inclined section 23A. As shown in FIG. 17, rear section 23C continues to the leading end of bottom section 23B in the extending direction.

As shown in FIG. 17, rear section 23C is inclined at angle θ2 in the pressing direction in which the upper mold (not shown) and lower mold 20A press the molten glass (in the present embodiment, in the vertical direction of the drawing sheet of FIG. 16). Here, angle θ2 is 10°.

Referring to FIG. 18, in Experiment 1, angle θ1 of inclined section 23A was set at four values below. The temperature of the upper mold and lower mold 20A was set at a value lower by 10° C. than the glass transition point (Tg) of the molten glass. The molten glass was pressed with the upper mold and lower mold 20A, and the temperature of the molten glass in the state where the molten glass had entered recess 23 was measured.

In Example 1A, angle θ1 was 45°. The temperature of the molten glass being dropped to lower mold 20A was raised in increments of 20° C., and a measurement was made as to whether or not the molten glass at each temperature had entered (had been transferred to) recess 23. In Example 1A, the temperature of the molten glass when transfer had been accomplished was 1040°. It can be seen that, when angle θ1 is 45°, a favorable positioning protrusion is obtained by setting the temperature of the molten glass at 1040°.

In Example 1B, angle θ1 was 60°. The temperature of the molten glass being dropped to lower mold 20A was raised in increments of 20° C., and a measurement was made as to whether or not the molten glass at each temperature had entered (had been transferred to) recess 23. In Example 1B, the temperature of the molten glass when transfer had been accomplished was 960°. It can be seen that, when angle θ1 is 60°, a favorable positioning protrusion is obtained by setting the temperature of the molten glass at 960°.

In Example 1C, angle θ1 was 70°. The temperature of the molten glass being dropped to lower mold 20A was raised in increments of 20° C., and a measurement was made as to whether or not the molten glass at each temperature had entered (had been transferred to) recess 23. In Example 1C, the temperature of the molten glass when transfer had been accomplished was 940°. It can be seen that, when angle θ1 is 70°, a favorable positioning protrusion is obtained by setting the temperature of the molten glass at 940°.

In Comparative Example 1, angle θ1 was 30°. The temperature of the molten glass being dropped to lower mold 20A was raised in increments of 20° C., and a measurement was made as to whether or not the molten glass at each temperature had entered (had been transferred to) recess 23. In Comparative Example 1, the molten glass did not enter recess 23, and transfer was not accomplished. No positioning protrusion was formed.

The results of Experiment 1 reveal that a favorable protrusion is formed on a glass optical element by setting angle θ1 at more than or equal to 45° and less than or equal to 70°.

### Experiment 2

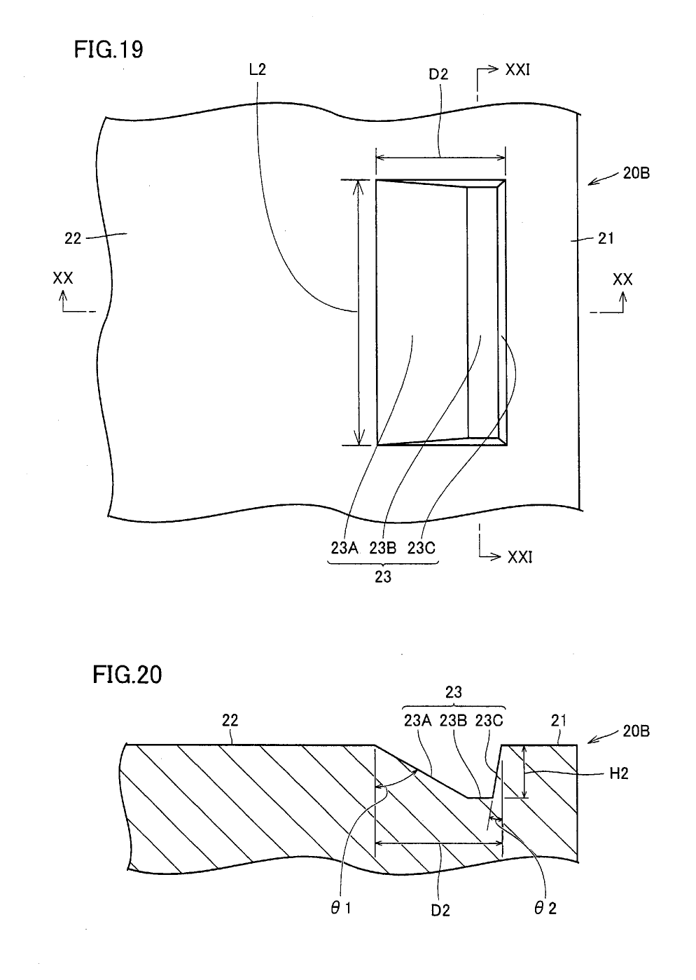

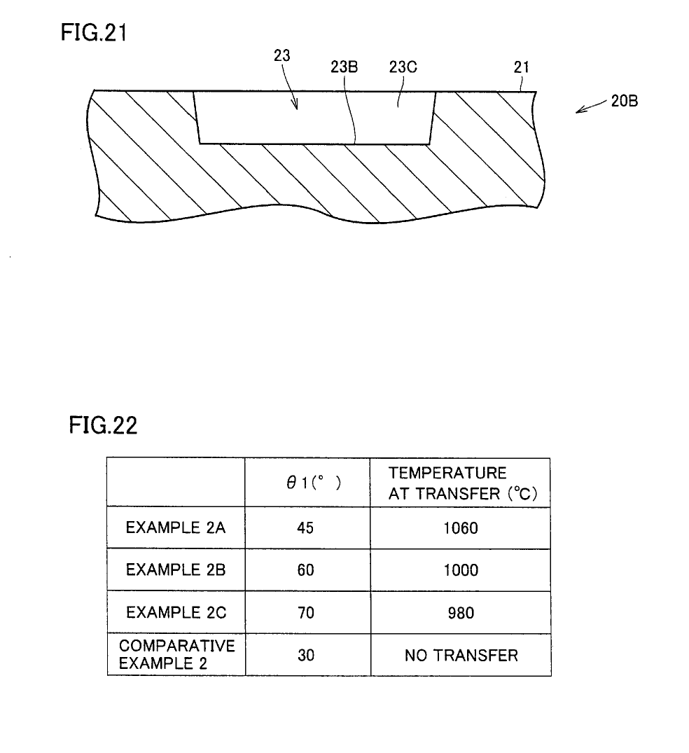

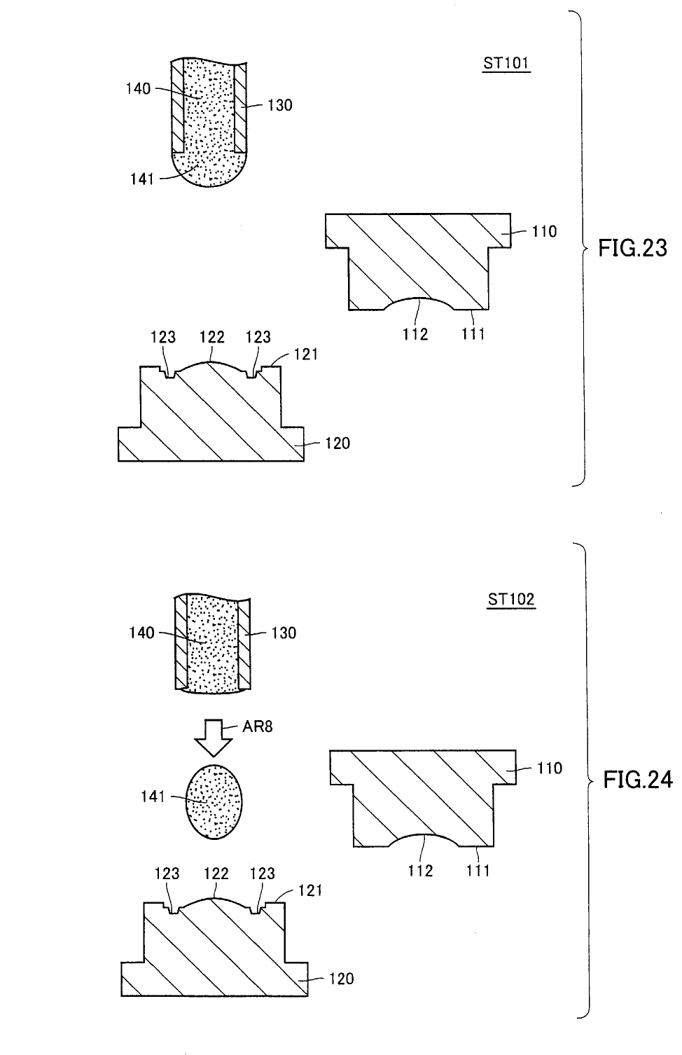

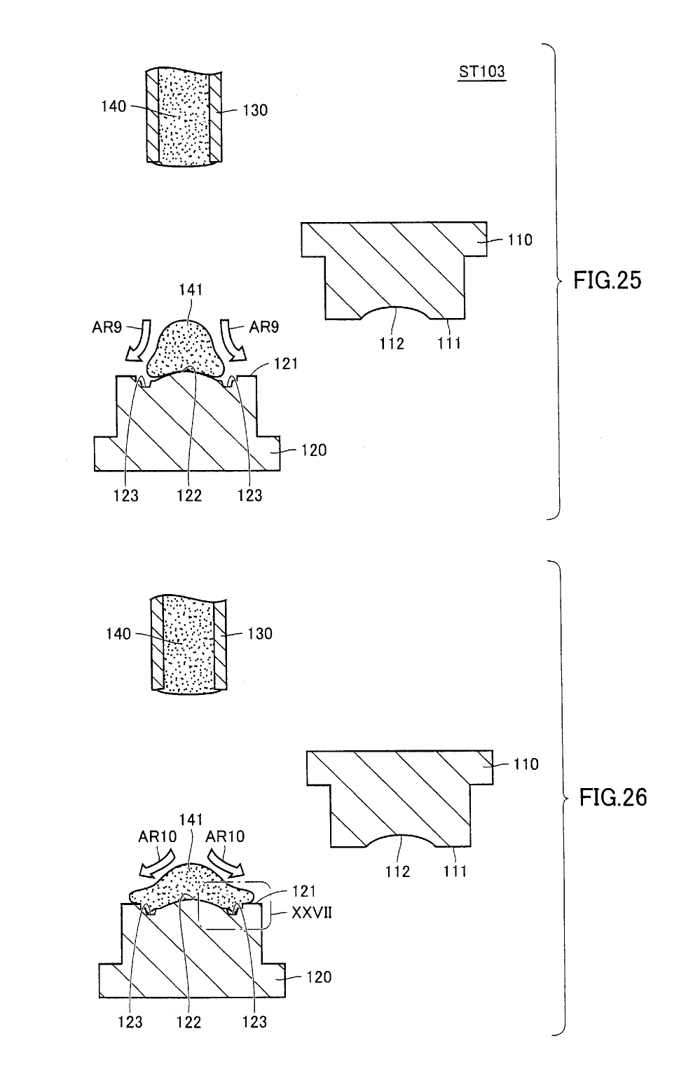

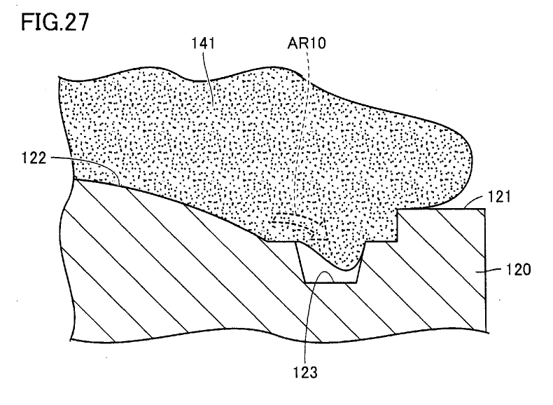

The results of Experiment 2 conducted based on the above-described first embodiment will be described. As will be described later in detail with reference to FIG. 22, Examples 2A, 2B, and 2C, and Comparative Example 2 with angle θ1 (see FIG. 20) varied from one another were conducted as Experiment 2. FIG. 19 is a plan view showing part of a lower mold 20B used in this experiment. FIG. 20 is a sectional view taken along the arrow line XX-XX in FIG. 19. FIG. 21 is a sectional view taken along the arrow line XXI-XXI in FIG. 19.

Referring to FIG. 19, lower mold 20B is provided with recess 23 between upper end surface 21 and molding surface 22. Recess 23 is formed into a generally rectangular shape as viewed two-dimensionally. Recess 23 has a length L2 of 2.4 mm in the vertical direction of the drawing sheet (perpendicular to the direction in which the molten glass spreads). Recess 23 has a width D2 of 1.4 mm.

Referring to FIG. 20, in lower mold 20B, molding surface 22 is formed flat. Recess 23 includes inclined section 23A, bottom section 23B, and rear section 23C, as inner circumferential surfaces. Recess 23 has a depth H2 of 0.6 mm. Inclined section 23A is located closer to molding surface 22, and continues to molding surface 22. The surface of inclined section 23A is formed as a flat plane without being curved. Inclined section 23A is inclined at angle θ1 in the pressing direction in which the upper mold (not shown) and lower mold 20B press the molten glass (in the present embodiment, in the vertical direction of the drawing sheet of FIG. 20).

Bottom section 23B continues to the lower end of inclined section 23A. Bottom section 23B extends horizontally away from inclined section 23A. As shown in FIG. 21, rear section 23C continues to the leading end of bottom section 23B in the extending direction.

As shown in FIG. 20, rear section 23C is inclined at angle θ2 in the pressing direction in which the upper mold (not shown) and lower mold 20B press the molten glass (in the present embodiment, in the vertical direction of the drawing sheet of FIG. 20). Here, angle θ2 is 10°.

Referring to FIG. 22, in Experiment 2, angle θ1 of inclined section 23A was set at four values below. The temperature of the upper mold and lower mold 20B was set at a value lower by 10° C. than the glass transition point (Tg) of the molten glass. The molten glass was pressed with the upper mold and lower mold 20B, and the temperature of the molten glass in the state where the molten glass had entered recess 23 was measured.

In Example 2A, angle θ1 was 45°. The temperature of the molten glass being dropped to lower mold 20B was raised in increments of 20° C., and a measurement was made as to whether or not the molten glass at each temperature had entered (had been transferred to) recess 23. In Example 2A, the temperature of the molten glass when transfer had been accomplished was 1060°. It can be seen that, when angle θ1 is 45°, a favorable positioning protrusion is obtained by setting the temperature of the molten glass at 1060°.

In Example 2B, angle θ1 was 60°. The temperature of the molten glass being dropped to lower mold 20B was raised in increments of 20° C., and a measurement was made as to whether or not the molten glass at each temperature had entered (had been transferred to) recess 23. In Example 2B, the temperature of the molten glass when transfer had been accomplished was 1000°. It can be seen that, when angle θ1 is 60°, a favorable positioning protrusion is obtained by setting the temperature of the molten glass at 1000°.

In Example 2C, angle θ1 was 70°. The temperature of the molten glass being dropped to lower mold 20B was raised in increments of 20° C., and a measurement was made as to whether or not the molten glass at each temperature had entered (had been transferred to) recess 23. In Example 2C, the temperature of the molten glass when transfer had been accomplished was 980°. It can be seen that, when angle θ1 is 70°, a favorable positioning protrusion is obtained by setting the temperature of the molten glass at 980°.

In Comparative Example 2, angle θ1 was 30°. The temperature of the molten glass being dropped to lower mold 20B was raised in increments of 20° C., and a measurement was made as to whether or not the molten glass at each temperature had entered (had been transferred to) recess 23. In Comparative Example 2, the molten glass did not enter recess 23, and transfer was not accomplished. No positioning protrusion was formed.

The results of Experiment 2 reveal that a favorable protrusion is formed on a glass optical element by setting angle θ1 at more than or equal to 45° and less than or equal to 70°.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A mold for use in production of a glass optical element, comprising:
an upper mold provided with a first molding surface; and
a lower mold on which a molten glass is dropped, said lower mold being provided with a second molding surface for press molding said molten glass with said first molding surface,
a recess for forming a positioning protrusion on said glass optical element being provided at an outer side of one of said first molding surface and said second molding surface,
an inclined section being provided at an inner circumferential surface of said recess closer to said one of said first molding surface and said second molding surface, and
said inclined section being inclined or curved such that, when said molten glass dropped on said second molding surface spreads toward said outer side, said molten glass enters said recess while maintaining contact with said inclined section.

2. The mold according to claim 1, wherein
said inclined section is formed flat, and
an angle formed by said inclined section and a pressing direction in which said upper mold and said lower mold press said molten glass is more than or equal to 45° and less than or equal to 70°.

3. The mold according to claim 1, wherein a plurality of said recesses are provided at said outer side of said one of said first molding surface and said second molding surface.

4. The mold according to claim 1, wherein said recess is provided at said outer side of said second molding surface.

5. A method of producing a glass optical element, press molding said molten glass using said mold as defined in claim 1, thereby producing said glass optical element.

6. A glass optical element produced by press molding said molten glass using said mold as defined in claim 1.
